(19) United States
(12) Patent Application Publication
(10) Pub. No.: US 2013/0140424 A1
(43) Pub. Date: Jun. 6, 2013

(54) Stand

(71) Applicant: LEICA MICROSYSTEMS (SCHWEIZ) AG, Heerbrugg (CH)

(72) Inventors: Roman Frick, Speicher (CH); Ulrich Sander, Rebstein (CH); Marco Schutz, Rorschach (CH)

(73) Assignee: LEICA MICROSYSTEMS (SCHWEIZ) AG, HEERBRUGG (CH)

(21) Appl. No.: 13/691,305

(22) Filed: Nov. 30, 2012

(30) Foreign Application Priority Data
Dec. 1, 2011 (DE) 102011119813.3

(51) Int. Cl. F16M 11/00

(52) U.S. Cl. CPC F16M 11/00
USPC 248/550; 248/125.1; 248/124.1; 248/123.11

(57) ABSTRACT

The invention relates to a stand for a surgical microscope (28) having a pivotable carrier arm (4). The latter is modifiable in length as a function of its pivot angle (29). It carries a microscope holder (6), pivotable in at least one plane, at the distal end of carrier arm (4), the angular position (21; 24) of the microscope holder (6) being definable with reference to the carrier arm (4; 34) according to a further development; and a motorized drive, which engages on the one hand on the carrier arm and on the other hand on the microscope holder (6), and in the context of operation defines the angular position (21; 24) in remotely controlled fashion and/or automatically.

### CROSS REFERENCE TO RELATED APPLICATIONS

This application claims priority of German patent application number 10 2011 119 813.3 filed Dec. 1, 2011, the disclosure of which is incorporated by reference in its entirety.

This application is also related to concurrently filed, co-pending, and commonly assigned application entitled “Stand,” bearing U.S. Ser. No. ______ and having internal reference number 033997.00187, claiming priority to German patent application number 10 2011 119 814.1 filed Dec. 1, 2011, the disclosures of which are hereby incorporated by reference in their entirety.

### FIELD OF THE INVENTION

The invention relates to a stand, in particular to a stand for a surgical microscope.

### BACKGROUND OF THE INVENTION

During the procedure surgical microscopes are as a rule positioned above a patient, or the surgical area to be observed is located on the patient and the surgeon looks down from above, along the main axis, onto the surgical area. The surgical microscope is accordingly located at a relative spatial position between the patient and the surgeon. The particular features of the patient or of the surgical area, and the ergonomic needs of the surgeon, are thereby optimally taken into consideration. This purpose has already been served for some time, as a rule, by handles with which the surgeon can move the surgical microscope together with its microscope holder and the carrier arm. Once a desired position has been found, releasable brakes prevent involuntary lowering or upward pivoting (in the case of overcompensated counterweighting) of the surgical microscope out of the selected spatial position.

Conventional surgical stands having the above-described pivotability of the carrier arm relative to a pivot bearing bracket described, with the distal end of the carrier arm, a circular trajectory around their pivot shaft in the pivot bearing bracket, as is evident e.g. from FIG. 1 of DE 10042272 A1.

In the case of the stand indicated in DE10042272 A1, the microscope carrier (5, 8) is held as described above by a carrier arm (3, 6) embodied as a parallelogram carrier arm. As is clearly evident from the indicated FIG. 1 of the existing art, the upward pivoting of the carrier arm also results in a parallel shift of the axis (G), and of the main axis (not depicted) parallel thereto of the microscope (9), to the left or toward the pivot shaft (4). Because this also causes the field of view of the surgical microscope to shift to the left, however, the surgeon obtains a different view of the surgical area. For low magnifications of the surgical microscope this shift may play no role, apart from the change in the Z distance (distance from the main objective to the surgical area). At greater magnifications, this can result in a need for correction. In such cases the surgeon would like to bring the surgical microscope, now at a raised elevation (dot-dash location of upper partial carrier arm (3)), the shaft (G), and thus also the main axis back into their original positions. This does not work for the stand of the indicated existing art as shown, since the stand is standing on the floor and does not permit the desired degree of freedom.

Further developments in the existing art have resulted in a solution to this problem. Early on, for example, stands operating according to the double-beam principle were created. Remaining with the example in FIG. 1 of the described existing art, the double-beam principle can be described as follows: If a further pivot bearing bracket, in which the vertical carrier arm (A) or the first-named pivot bearing bracket and its shaft (4) could be pivoted out the perpendicular, were located e.g. at point (2a) or therebelow, the surgeon could then, as desired above, pull the surgical microscope forward again when the brakes are released, despite the elevated position resulting from the upward pivoting (dot-dash line) of the carrier arm, in order to bring shaft G or the main axis back into their original spatial position. In this case the vertical carrier arm (A) would pivot to the right around the axis at (2a).

The surgical stands embodied in this fashion constitute the present-day standard for surgical microscopy. As indicated above, they permit a surgical microscope to be positioned more or less as desired in space, and the problems described above can be eliminated with these constructions; surgeons are thus able to make changes to the pivot position of the carrier arm without encountering the disadvantageous effects indicated above.

Disadvantageously, however, they require a certain skill in dealing with such surgical stands. Leaving that aside, stands of this kind constructed on the double-beam principle are extremely expensive.

Examples of such known constructions are found in U.S. Pat. No. 5,528,417 A and EP 628290 A1; these also indicate the manner in which microscope mounts held by parallelogram carrier arms of double-beam stands are to be held in a perpendicular position even upon pivoting of the parallelogram carrier arm. This occurs by way of a lever-like brace (crank member) on a vertical stand carrier arm, which is connected on the one hand via a tie rod to the microscope holder, and on the other hand to a non-pivotable stationary part of the surgical stand. This construction has already been disclosed previously in the art in the context of a wide variety of designs, for example in the design of light sources held in the manner of a beam balance for desk lamps, or the like.

If the surgeon does not possess the necessary skill or experience, however, and if the magnification set on the surgical microscope is perhaps also very high, then despite lever-like bracing, simply positioning the surgical microscope (in some cases only a little bit) higher causes the specimen or the surgical field to quickly escape away of the center of the observation field or entirely out of it. This can result in disorientation, and can require repositioning of the surgical microscope. This, however, leads to a loss of time during the procedure, which is not only undesirable but can also in fact be inherently disadvantageous in terms of the procedure.

The object of the present invention is thus to create a novel stand that avoids the problems indicated above, preferably without resorting to the double-beam principle and thus in economical fashion.

### SUMMARY OF THE INVENTION

The novel stand is intended essentially to exhibit only slight technical modifications, however, so that a majority of the components used hitherto can be reused (including parts of stands according to the double-beam principle).

The stand is intended in particular to allow the surgeon to perform elevation adjustments on the surgical microscope without thereby necessarily displacing the main axis in space or with reference to a perpendicular.

The invention is usable regardless of the type of weight compensation for the load and in particular for the surgical microscope. The invention can be utilized both in stands constructed on the beam balance principle and with gas-spring-supported carrier arms.

The result of the fact that the carrier arm is variable in terms of its length as a function of the angular position, so that the microscope holder is variable in terms of its elevation along a perpendicular, is that the shifting effect on the surgical microscope caused by the arc effect is absent.

In the simplest embodiment, the carrier arm is embodied so it can be pulled out, so that once the brakes have been released, the surgeon pulls the surgical microscope forward (i.e. along an extension of the lengthwise axis of the carrier arm) simultaneously with raising it or, when lowering the surgical microscope (at most to a horizontal position of the carrier arm) shifts it simultaneously in the direction of the carrier arm so as to remain with the main axis along the same perpendicular or in the same position relative to that perpendicular.

This simple implementation of the invention has the disadvantage that once again a certain skillfulness is needed, in that the surgeon performs the change in the position of the surgical microscope with a certain sensitivity, or while continuously observing the surgical field through the surgical microscope and continuously readjusting the length of the carrier arm.

The invention is therefore further developed in this regard if the carrier arm (4) is variable in terms of its length automatically, i.e. in a manner coupled to the angular position (29). This is brought about, in particular and by way of example, by the fact that the carrier arm can be lengthened and shortened in motorized and sensor-controlled fashion.

A control system, which defines the length variation as a measured function of the pivot-angle position of the carrier arm, is preferably provided for this.

There are many possibilities for implementing the invention. For example, the carrier arm can comprise foldable angle elements that are displaceable in motorized fashion. The carrier arm can, however, also in particular be telescopically extendable, which makes possible not only an elegant appearance but also a space-saving implementation. Drives for telescopic length modification can be arranged outside or inside the carrier arm.

Integrated, telescopic constructions are preferred for the purpose of avoiding surfaces, which in any event need to be cleaned.

According to an embodiment of the invention, the stand is constructed so that the pivotable carrier arm is embodied as a single tier or single piece, and as an arm that is tubular or profile-shaped in section. This results in a slender, lightweight construction that leaves a great deal of space open for the surgeon and can be easily implemented.

A more stable variant of this is obtained if the pivotable carrier arm, as known per se, is embodied as two tiers or with multiple parts, preferably as a trapezoidal carrier arm; and that each of the carrier arm parts is embodied as an extendable arm that is tubular or profile-shaped in section, each of said carrier arm parts being extendable.

A construction of this kind is, as is known per se, realized as a rule with the aid of parallelogram carrier arms.

The underlying theory is that with a parallelogram support, the load that is acting can be correctly positioned and held without bending. It is found in practice, however, that even parallelogram supports are subject to a certain bending. This is influenced differently by the weight of the load, however. In the case of a surgical microscope, the load is a surgical microscope having a very wide variety of accessories. Because the different accessories generally entail a different weight loading, a difference in the deflection of the carrier arm structure of course occurs. This is particularly the case with a single-tier carrier arm but also, as already mentioned, with a parallelogram support.

A difference in bending because of a different load weight can thus results, even with the design according to the present invention, in a weight-dependent difference in the spatial positioning of the microscope holder, and thus in a weight-dependent spatial positioning of the surgical microscope.

This in turn results, when an accessory change occurs on the surgical microscope, in a displacement of its optical main axis with reference the surgical site. This in turn leads, in some circumstances, to a need for readjustment of the surgical microscope and/or of the stand, although this is undesirable during a surgical procedure for the reasons already indicated above.

According to a particular embodiment this disadvantage is at least partly compensated for by the fact that the carrier arm, or at least one of the carrier arm parts, is braced in weight-compensating fashion by a bracing spring with respect to the pivot bearing bracket or with respect to a vertical stand element or with respect to a vertical carrier arm. This spring can be arranged, as is usual per se with parallelogram supports, between the upper and the lower carrier arm part, but can also be located on the other side of the pivot bearing bracket in order to brace a carrier arm or carrier arm part that has been extended to that point. Reference is made to concurrently filed, co-pending, and commonly assigned application entitled “Stand,” bearing U.S. Ser. No. ______ and having internal reference number 033997.00187, claiming priority to German patent application number 10 2011 119 814.1 filed Dec. 1, 2011.

Alternative weight compensation systems, known per se, are likewise within the scope of the invention. Weight compensation systems entirely in beam-balance form, however, do not affect the aforementioned disadvantageous deflection.

In order to compensate fully for this, and to eliminate the deviation, associated therewith, of the main axis from its original location or from the perpendicular, provision is made according to a further development of the invention to ascertain the tilt of the stand holder or of the surgical microscope by means of measurement sensors, and to compensate for it by means of a positioning motor.

The apparatus for defining said angular position now no longer encompasses rods, bearings, and levers as is known and set forth above, but instead merely at least one motorized drive, in particular a positioning motor, that engages on the one hand on the carrier arm and on the other hand on the microscope holder, and in the context of operation defines the angular position between the microscope holder and the carrier arm in remotely controlled fashion and/or automatically. As a sensor, the particular desired one can be selected from the following non-exhaustive list of sensors: tilt sensor, height sensor, angle sensor, spatial coordinate sensor (e.g. IR sensor).

As a motorized drive for lengthwise displacement, and also for the first and/or the other positioning motor, at least one electrical drive can derive from the following non-exhaustive list of drives: electric motor, geared motor, linear motor, rotary stepping motor, electroactive polymers (EAP), pneumatic cylinder, electropneumatic drive, etc.

This improved construction according to the present invention achieves the further stated object regarding deflection compensation, which can play a relatively large role especially with supports or carrier arms elongated according to the present invention. This novel construction not only results in ideal angle compensation that is entirely independent of deflection and of the weight of the load or of the surgical microscope, and reacts consistently correctly to any pivot angle of the load arm, but also results in elimination of the hitherto considerable mechanical components.

This construction according to the present invention achieves the stated object. Not only does this novel construction result in ideal angle compensation that is entirely independent of deflection and the weight of the load or of the surgical microscope, and react in a consistently correct manner to any pivot angle of the load arm; it also results in elimination of the hitherto considerable mechanical components.

It thus results in a weight reduction, and also allows the parallelogram support, usual per se, to be replaced by simple tube or profile designs in which bending is deliberately accepted. The overall structure of the stand becomes lighter as a result, in particular also thanks to a reduction in the weight of balance weights, which of course become lighter when the carrier arm itself becomes lighter. The construction according to the present invention furthermore makes possible a more compact and improved design. It further reduces complexity in the context of draping (covering with a sterile protective film). Here again, reference is made to concurrently filed, co-pending, and commonly assigned application entitled “Stand,” bearing U.S. Ser. No ______ and having internal reference number 033997.00187, claiming priority to German patent application number 10 2011 119 814.1 filed Dec. 1, 2011.

According to a particular embodiment of the invention, such angle compensations can also be provided outside the pivot plane of the carrier arm, in particular orthogonally or transversely thereto. According to this particular embodiment, an additional drive is provided for such compensation measures. In a stand further developed in this fashion, the suspension system of the microscope holder can be spherical or can have two bearing axes arranged one above another and transversely to one another.

In order to ensure fail-safe operation, it is advantageous if the microscope holder is suspended with respect to the carrier arm in such a way that it automatically pivots or swings under its own weight, if the first and/or the other drive or motor is inactive, at least approximately into a stipulated angular position—in particular, close to the perpendicular—or is subject at least to a torque in the direction of that close-to-perpendicular position in order to reach that position.

Leaving aside any fail-safe operation, the result of an improved further development is that the microscope holder is suspended with respect to the carrier arm in such a way that its center of gravity is located to the side of a perpendicular through the suspension, in particular to the side of a pivot shaft and/or to the side of a rotation axis of the microscope holder, and in the operating state the first and/or the other drive or positioning motor automatically absorbs the resulting torque in order to pivot the microscope holding apparatus into the desired angular position, preferably into the perpendicular. What is achieved thereby is that the positioning motors are under less load or can require less energy consumption, and accordingly can also be physically small.

The configuration according to the present invention with angle-compensating positioning motors moreover advantageously allows the microscope holder to be suspended with respect to the carrier arm with a clearance that, in the operating state, is compensated for or set to zero clearance by the first and/or the other drive or positioning motor. This allows an economical embodiment of the bearings, while the precision of the surgical stand is nevertheless sufficient.

The construction according to the present invention is simplified if a control system is provided which defines the definition of the angular position(s) as a function of the pivot-angle position of the carrier arm. This control system need not obligatorily be an independent control system, for example a control chip directly in the region of the positioning motor(s); it can also be integrated, in hardware or software, into the computer that is normally present in the surgical stand or the surgical microscope.

Complete automation is made possible if a measurement apparatus, in particular a sensor, is provided, which, in the operating state, triggers the control system or the first positioning motor and/or the other positioning motor to define the angular position(s) as a function of the pivot-angle position of the carrier arm.

A sensor of this kind is preferably attached at the distal end of the carrier arm or on the microscope holder itself, in order to ascertain in situ the actual position of the carrier arm or of the microscope holder.

According to a further development of the invention, the drives for length modification and/or the first and/or the other positioning motor are embodied in self-locking fashion. The result of this is that unintentional displacement cannot occur in the currentless state, which contributes to safe operation. On the other hand, the self-locking feature can thereby act as a brake, so that in currentless mode the surgeon can overcome the self-locking by force and make any desired adjustments in that manner.

A variant of this construction results if the drive or the first and/or the other positioning motor is embodied in decouplable fashion in the manner of a releasable brake.

The further development of the invention results in any event in a device on the surgical stand for ensuring a continuously perpendicular position of the microscope carrier or of the microscope.

Another advantageous further development of the invention results if the carrier arm is telescopically extendable (see FIG. 5). The result of this construction, in combination with the advantages of the invention that have already been recited above, is not only that upward pivoting of the carrier arm can be compensated for, according to the present invention, with respect to the tilt of the microscope holder, but also that the location of the main axis of the surgical microscope can remain at the same distance from the stand body or from the stand axis.

This is achieved, for example, by the fact that a pivot motion out of the horizontal automatically results in an elongation of the carrier arm, in the same ratio at which the distance would be shortened by the pivoting. Reference is made in this regard to concurrently filed, co-pending, and commonly assigned application entitled “Stand,” bearing U.S. Ser. No. ______ and having internal reference number 033997.00187, claiming priority to German patent application number 10 2011 119 814.1 filed Dec. 1, 2011.

Further advantages, features, and details of the invention are evident from the description below, in which exemplifying embodiments of the invention are described with reference to the drawings. Features mentioned in the description may be essential to the invention each individually of themselves or in any combination.

The list of reference characters is a constituent of the disclosure. The Figures are described in continuous and overlapping fashion. Identical reference characters denote identical components. Reference characters having different indices indicate functionally identical or similar components.

### BRIEF DESCRIPTION OF THE DRAWINGS

FIG. 1 shows a stand having an elongation capability according to the present invention of the carrier arm;

FIG. 2 shows a detail of a variant of the construction according to FIG. 1;

FIG. 3 shows a symbolically depicted variant of FIG. 1 having a single-tier carrier arm;

FIG. 4 is a section through a detail of FIG. 3;

FIG. 5 is a partial section of a variant having a telescopically extendable carrier arm 4b, 4c;

FIG. 6 shows a distal upper part of a surgical stand having a carrier arm 4a of a first embodiment of a surgical stand according to the present invention, omitting drives and details of the extendability of the carrier arm;

FIG. 7 is a view from above of the construction of FIG. 6, but with a complete carrier arm and pivot bearing bracket;

FIG. 8 shows the construction of FIG. 6 obliquely from the front;

FIG. 9 shows the construction of FIG. 6 with carrier arm 4a removed, obliquely from behind;

FIG. 10 shows an enlarged detail of positioning motor 23 for microscope holder 6 of FIG. 6;

FIG. 11 is a view from the front of a further development having another positioning motor 22;

FIG. 12 shows a detail of the construction according to FIG. 11;

FIG. 13 shows a variant of the construction of FIG. 1 with a pivotable vertical carrier arm 40 and a single-tier carrier arm; and

FIG. 14 shows a variant of the construction of FIG. 13 with a two-tier carrier arm 34, 4c and 4d.

### DETAILED DESCRIPTION

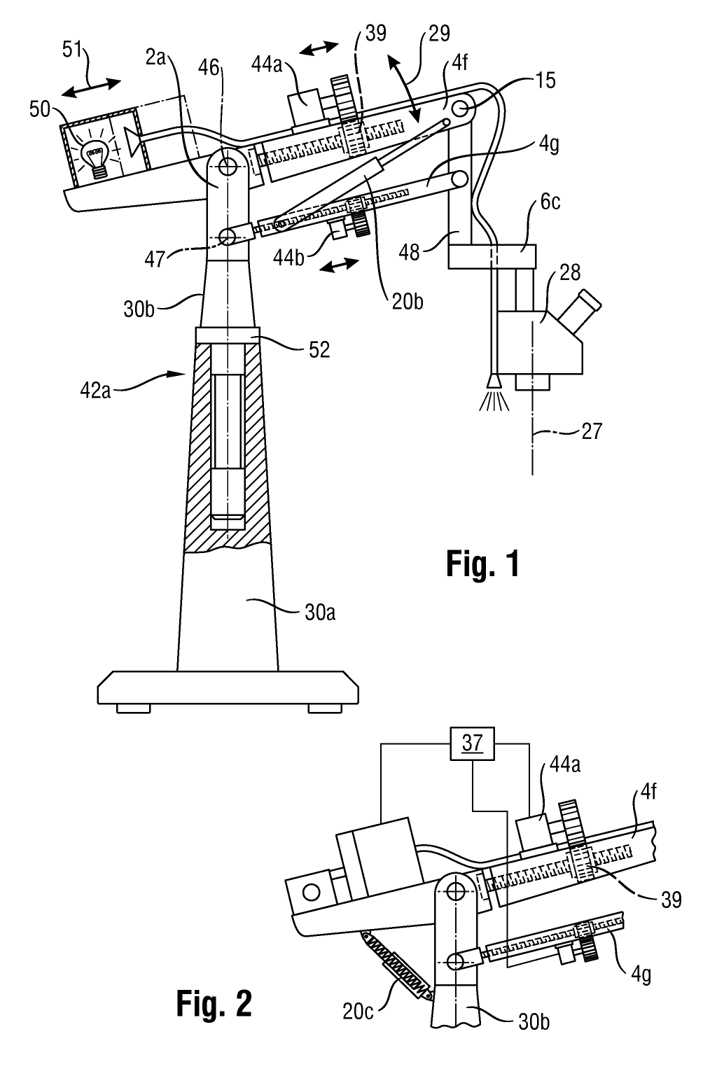

FIG. 1 shows a conventional stand according to DE 10042272 A1, but having an elongation capability according to the present invention of the carrier arm or of the parts of carrier arm 4f, 4g that are assembled with their proximal and distal ends into a parallelogram carrier arm. The two parts of carrier arm 4f and 4g thus form the upper and the lower tier of a two-tier carrier arm. Each of the partial carrier arms 4f and 4g is embodied to be extendable (preferably simultaneously and to the same distance), so that the distance between the distal end and the proximal rotation axes 46 and 47, respectively, of said partial carrier arms 4f, 4g can be increased or decreased. These length modifications are usually carried out synchronously and over the same length, but special embodiments in which the two partial carrier arms can be extended to different lengths, so as thereby to effect arbitrary positioning of a microscope holder 6c that is articulatedly connected via a carrier part 48 to the distal ends of the parts of carrier arm 4f and 4g, are also within the scope of the invention.

It is critical and in accordance with the invention that when carrier arm 4f, 4g is angularly displaced upward in the direction of double arrow of angular position 29, the two parts of carrier arm 4f, 4g can be extended sufficiently far that main axis 27 of surgical microscope 28 remains in the same perpendicular, as in the position presently shown.

A bracing spring 20b supports the parallelogram and in that context acts in weight-compensating fashion on the load of the surgical microscope. Brakes (not shown) serve to define a specific pivot position of carrier arm 4f, 4g relative to its pivot bearing bracket 2a, which forms the distal part of a vertical carrier arm 30b of the surgical stand or stand body 42a. That part of the upper part of carrier arm 4f which projects to the left beyond its pivot bearing 46 carries as a balancing weight a symbolically depicted illumination device 50 that is shiftable in accordance with double arrow 51 on the part of carrier arm 4f (see also dot-dash position). The shiftability is preferably automatic and motorized, and is not depicted further. The shiftability offers a capability of influencing the balance that changes as a result of the elongation of the parts of carrier arm 4f, 4g.

This symbolic depiction can of course be replaced by any desired variants, in particular if a different illumination device is selected. Conventional shifting devices can effect the shift, and are therefore not discussed further.

The upper vertical carrier arm 30b is connected via a rotary bearing 52 to a lower vertical carrier arm 30a that stands on the floor via a stand foot.

The elongation capability of the parts of carrier arm 4f and 4g is achieved by way of one spindle each that connects a left and a right part of the partial carrier arms in motor-drivable fashion. As symbolically depicted, drive 44a, 44b for the spindles is located outside the parts of carrier arm 4f, 4g, and engages via a gear wheel or via a toothed belt or the like onto a respective threaded bushing 39 that is mounted axially nondisplaceably in the respective part of carrier arm 4f, 4g and receives a respective threaded spindle that is fastened in the respective second part of each part of carrier arm 4f, 4g rotatably but in axially lossproof fashion. When threaded bushing 39 is rotated, this results in a lengthwise displacement of the threaded spindle, and thereby in an expansion or contraction of a break point between the respective parts of the parts of carrier arm 4f, 4g. These parts are of course rail-mounted with respect to one another so that the partial carrier arms have a degree of freedom only in their lengthwise direction.

Further details of this construction may be gathered from DE 10042272 A1.

FIG. 2 shows a variant of the construction of FIG. 1. This shows, instead of bracing spring 20b between the parts of carrier arm 4f and 4g, a bracing spring 20c that supports the part of carrier arm 4f with respect to upper vertical carrier 30b, and thus provides weight compensation. The advantage of this construction is that the space in the interior of the parallelogram is open, and visibility in the operating room is therefore also less impeded.

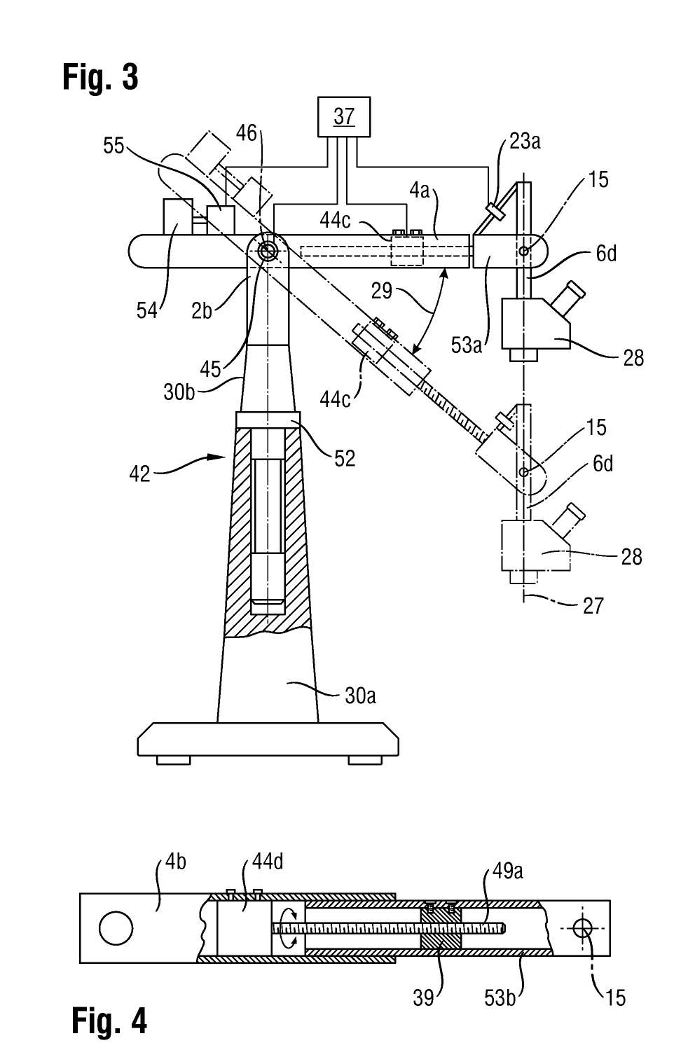

Even better visibility is provided, however, by the construction according to FIG. 3, that possesses only a single carrier arm 4a. With this construction, on the one hand a balance weight 54 shiftable by means of a shifting motor 55 is symbolically depicted. Carrier arm 4a is mounted on pivot bearing bracket 2b. Arranged around bearing axis 46 is an angle measurement sensor 45 that measures the relative position between carrier arm 4a and pivot bearing bracket 2b, and conveys the measured values to an electronic control system 37. This in turn controls drive 44c for the threaded spindle for lengthening carrier arm 4a. The symbolically depicted construction is different here in that drive 44c is an electric motor having as a rotor an internally located threaded bushing 39 that receives the spindle, which carries at its distal end a shiftable part 53a of carrier arm 4a. This part 53a carries microscope holder 6d via a microscope holder pivot shaft 15. This construction is further developed in that it furthermore carries another first positioning motor 23a that is secured at one end on part 53a of carrier arm 4a and at the other end on microscope carrier 6d, so that upon excitation it can adjust in remotely controlled fashion the angle between the components just recited. Remote control is effected via control system 37, which executes the displacement instructions on the basis of the measured angular position (29) at angle sensor 45. The result of this additional construction is that for a specific angular position (29), a specific angular setting of microscope holder 6d relative to carrier arm 4a is effected. At the bottom position (depicted lowered and with dot-dash lines) of surgical microscope 28, it is evident what control system 37 is capable of doing via drives 44c and 23a: it holds main axis 27 on or in the same perpendicular, even though the elevation of surgical microscope 28 has been changed and the carrier arm has been correspondingly pivoted.

FIG. 4 shows a variant of the construction according to FIG. 3; here an internally located drive 44d is secured inside carrier arm 4b. It carries a threaded spindle 49a that in turn is held in a threaded bushing 39 that in turn is secured in a part 53b of carrier arm 4b. Part 53b is guided with its external profile on the internal profile of carrier arm 4b, so that it exhibits true telescopic characteristics.

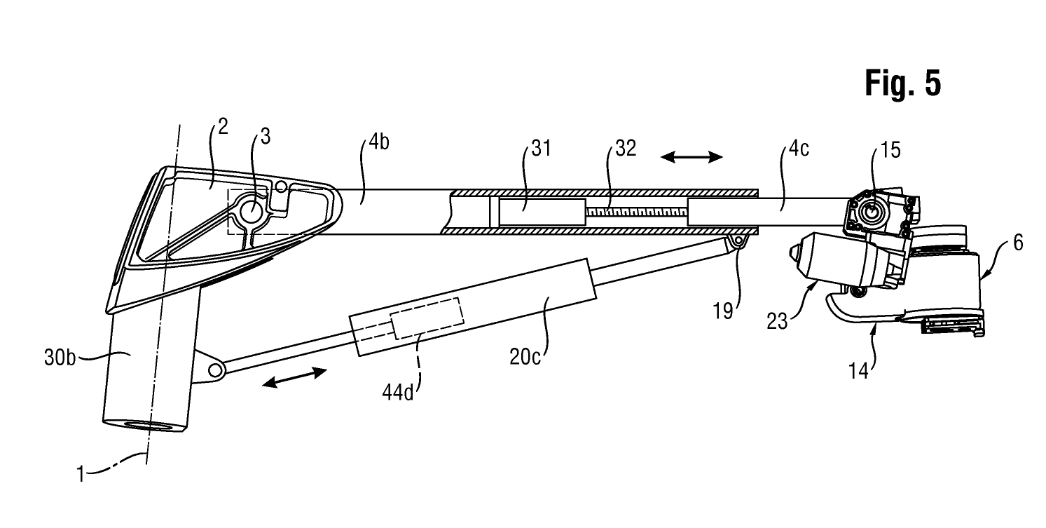

FIG. 5 shows a variant having a two-part carrier arm 4b (outer) and 4c (inner part). A telescope motor 31 (drive) can shift the two parts of carrier arm 4b and 4c with respect to one another via a telescope spindle 32, with the result that the carrier arm length can be adjusted. Although not shown in more detail, bracing spring 20c either also has a telescope elongation capability activatable in parallel—as merely indicated (44d)—or is adjusted in terms of its spring characteristic curve so that it automatically applies the different bracing force depending on the length of the carrier arm.

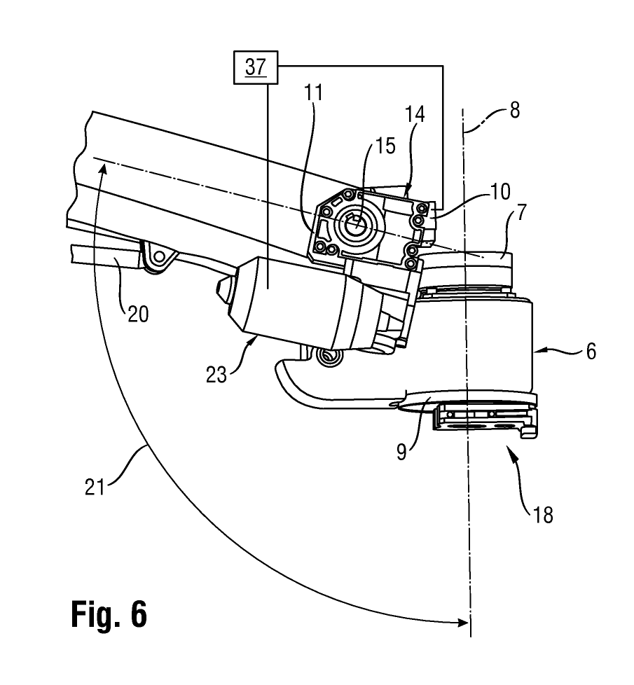

FIG. 6 shows the distal part of a carrier arm 4a with special equipment that is also indicated in particular in concurrently filed, co-pending, and commonly assigned application entitled “Stand,” bearing U.S. Ser. No. ______ and having internal reference number 033997.00187, claiming priority to German patent application number 10 2011 119 814.1 filed Dec. 1, 2011:

At the distal end of bracing spring 20, it is fastened pivotably to an articulation flange 19.

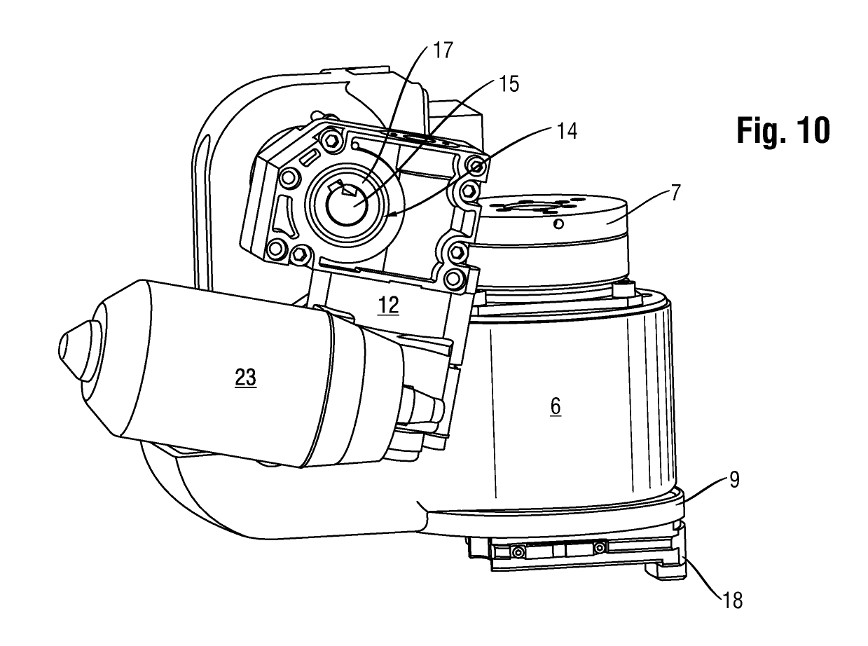

Located at the distal end of carrier arm 4a is a microscope holder pivot shaft 15 that carries a microscope holder 6. The latter symbolically shows a rotation axis 8 for surgical microscope 28 that can be connected to a microscope interface 18 (FIG. 10). Microscope interface 18 is located on a pivot bearing 9 for surgical microscope 28, which can be immobilized by means of a brake 7.

In order for surgical microscope 28 and its microscope holder 6 to be adjusted in terms of angle with respect to carrier arm 4a and/or with respect to the perpendicular, a first positioning motor 23 is provided which performs, via a right-angle drive train 14, tilt adjustment of microscope holder 6 relative to the perpendicular, or ensures the perpendicular position thereof. Angular position 21 is fundamentally not relevant but is nevertheless an indication of the desired setting.

FIG. 6 moreover shows a tilt sensor 10. This sensor is installed on microscope carrier 6. Its purpose is to measure any deviation from the vertical position and to generate corresponding positioning instructions by means of which first positioning motor 23 is driven in order to establish the vertical position. An adapter flange 11 for right-angle drive train 14 is depicted.

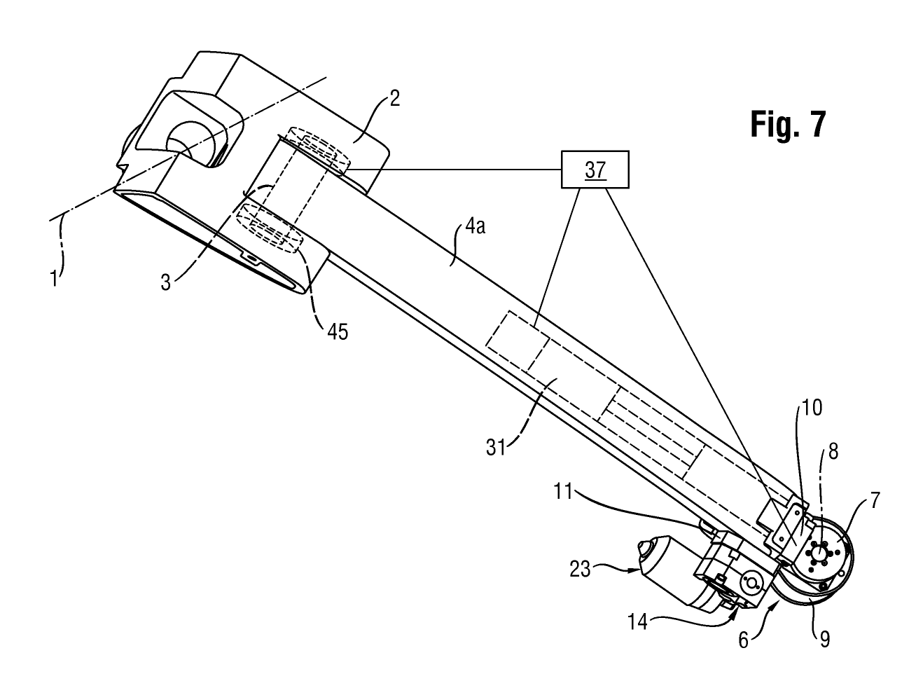

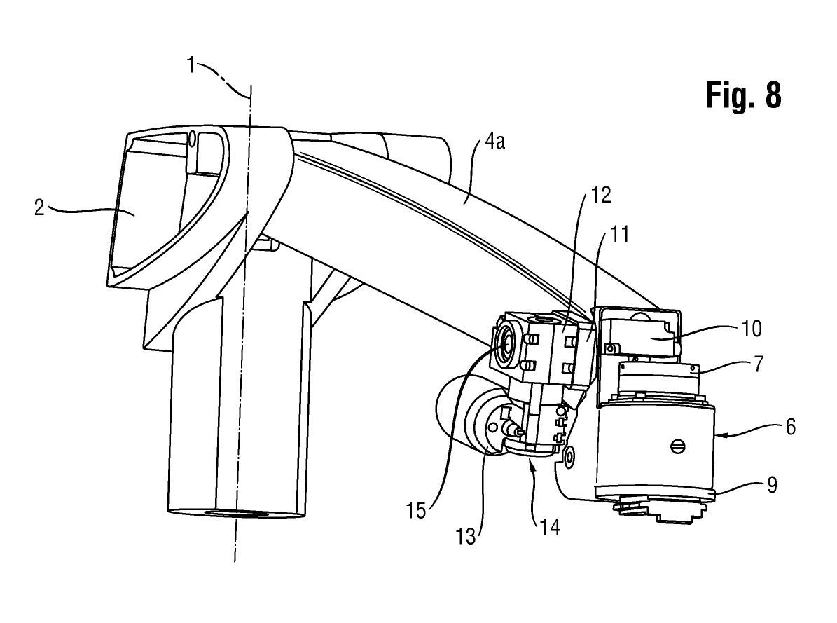

As an alternative to this sensor 10, an angle sensor 45 could also be arranged around pivot arm bearing shaft 3, as depicted in FIG. 7. The pivot angle measurable there is an angle complementary to angle value 21 (FIG. 6) that indicates the angular position between carrier arm 4a and rotation axis 8, which in any case runs parallel to main axis 27 of surgical microscope 28. First positioning motor 23 could thus also be activated by way of this value.

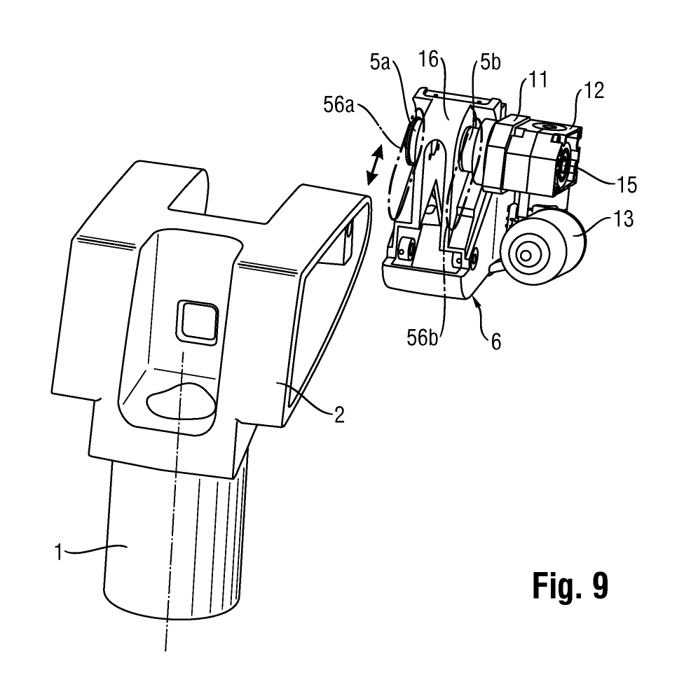

FIG. 9 shows in detail the manner in which, in this exemplifying embodiment, microscope holder pivot shaft 15 is held by means of support bearings 5a and 5b in carrier arm 4a, and on the other hand receives microscope holder 6 on its bearing bracket 16. Also evident is the manner in which, by way of example, two slide guides 56a and 56b are provided to the side of bearing bracket 16, these on the one hand receiving bearings 5a and 5b and at the other end being secured in carrier arm 4 (not depicted). They thus represent a further variant of the carrier arm elongation systems previously shown.

FIG. 10 provides a better view of hollow drive shaft 17 that ensures energy transfer between right-angle drive train 14 and the carrier arm. The right-angle drive train together with first positioning motor 23 is installed at the distal end of carrier arm 4a. An actuation of the motor produces, via the right-angle drive train, a rotary motion of pivot shaft 15 which nonrotatably entrains bearing bracket 16, and thus causes a change in angular position 21.

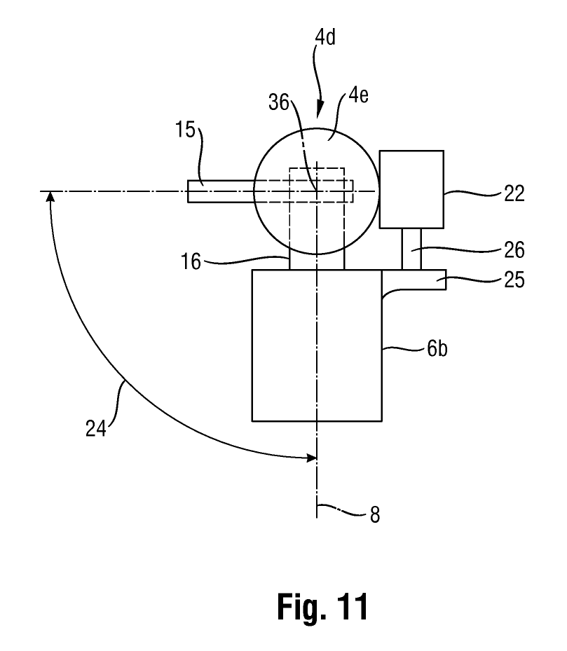

Carrier arm 4d, 4e is once again split in two in the construction according to FIG. 11, but this time in order to enable a pivoting motion of the microscope holder around a rotation axis 36 in carrier arm 4d, 4e. For example, a pivot angle 24 can also be described or, as symbolically depicted, another positioning motor 22 connected to carrier arm 4d can adjust angular position 24, which motor can provide positioning feed via a positioning member 26 and a bracing surface 25 on microscope holder 6.

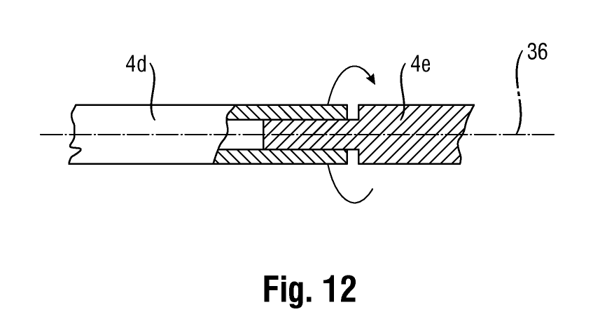

FIG. 12 symbolically shows the connection of the rotatable carrier arm parts 4d and 4e.

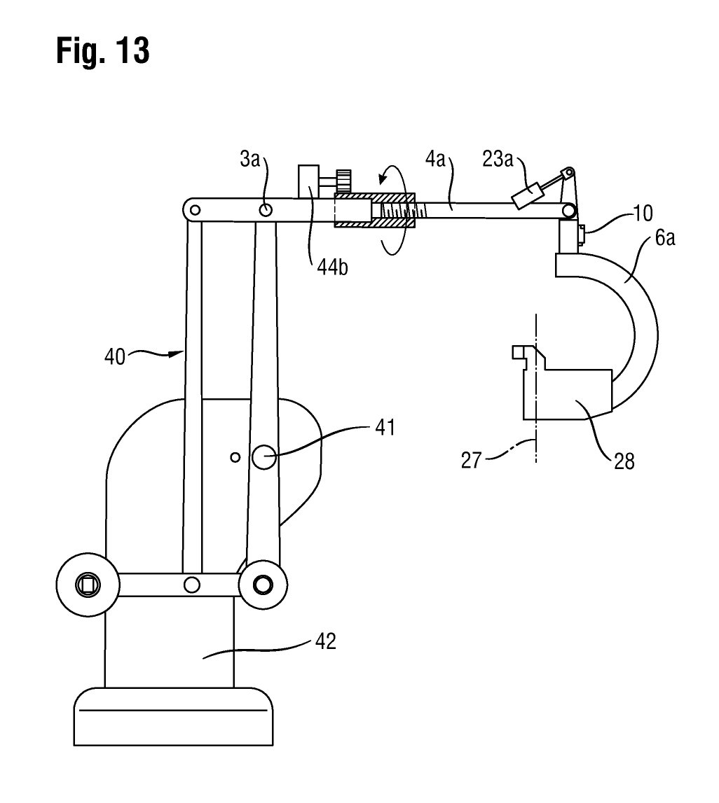

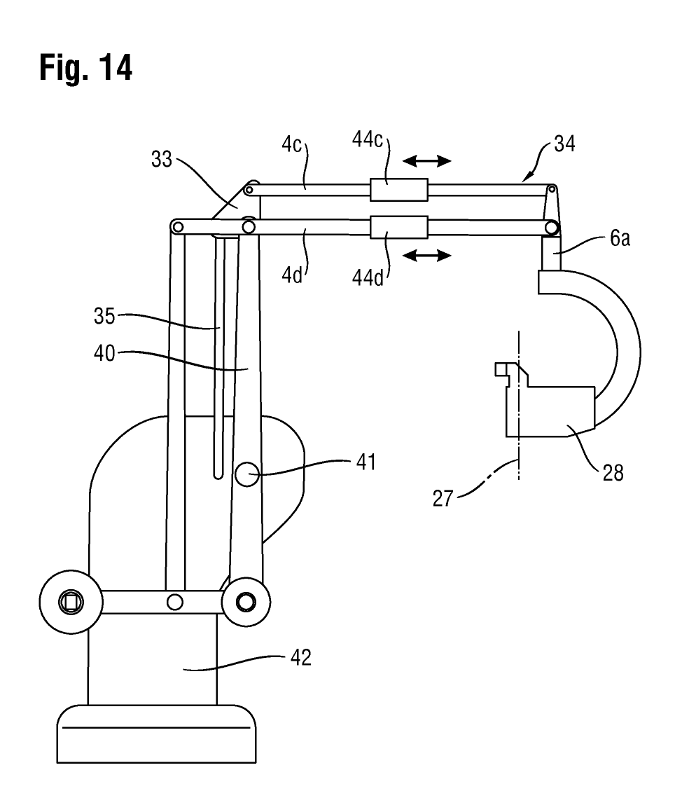

FIG. 13 shows a variant having a pivotable vertical carrier arm 40 that is constructed, in accordance with the existing art, as a parallelogram carrier arm (double-beam principle, in contrast to the construction according to FIG. 1). A vertical parallelogram carrier arm 40 is pivotable around a shaft 41 in stand body 42. In contrast to the principle from the existing art according to FIG. 14 (parallelogram carrier arm 34), however, carrier arm 4a is embodied here as a single tier or single arm, whereas according to FIG. 14 it is again constructed as a parallelogram carrier arm 34. Another first positioning motor 23a, depicted here as a spindle drive, once again ensures the correct angular position of microscope carrier 6a relative to the perpendicular or relative to carrier arm 4a. A drive 44b serves, together with a peripheral threaded bushing and a threaded spindle engaging thereinto, for elongation of the carrier arm.

FIG. 14 symbolically illustrates a modified stand of the existing art for compensating for pivot-angle position 29 on the microscope holder. The upper rod in parallelogram carrier arm 34, transfer part (crank member) 33, and tie rod 35 that is perpendicular in the image and is connected at its proximal end to stand body 42, cause microscope carrier 6a always to remain in a perpendicular position regardless of the pivot state of parallelogram carrier arm 34 or the pivot state of vertical carrier arm 40. What is novel with respect to the existing art, however, is the elongation capability of the two parts of carrier arm 4c and 4d of parallelogram carrier arm 34. Drives 44c and 44d serve for the elongation capability according to the present invention.

The following may be stated in summary: The invention relates to a stand and a surgical microscope 28 having a pivotable carrier arm 4. The latter is modifiable in length as a function of its pivot angle 29. It carries a microscope holder (6), pivotable in at least one plane, at the distal end of carrier arm 4, angular position 21; 24 of microscope holder 6 being definable with reference to carrier arm 4 according to a further development; and a motorized drive, which engages on the one hand on the carrier arm and on the other hand on microscope holder 6, and in the context of operation defines angular position 21; 24 in remotely controlled fashion and/or automatically. The construction facilitates utilization by a surgeon and ensures that he or she has an identically oriented view of the surgical field even after changes in the elevation of the surgical microscope (28).

Reference characters without indices denote, in this application, all identically named reference characters including their different indices.

The invention is not to be limited to the specific embodiments disclosed, and modifications and other embodiments are intended to be included within the scope of the invention.

### LIST OF REFERENCE CHARACTERS

1 Stand axis
2, 2a, 2b, 2c, 2d Pivot bearing bracket
3, 3a Carrier arm bearing axis
4, 4a, 4b Carrier arm, telescoping arm (outer)
4c Carrier arm, telescoping carrier arm (inner)
4d Part of carrier arm (outer) with rotary bearing
4e Part of carrier arm (inner) in rotary bearing
4f, g Part of carrier arm
5, 5a, 5b Support bearing
6, 6a, 6b, 6c, 6d Microscope holder
7 Brake for rotary motion of surgical microscope
8 Rotation axis for surgical microscope
9 Rotary bearing for surgical microscope
10 Pivot/tilt sensor
11 Adapter flange
12 Drive train housing
13 Motor housing
14 Right-angle drive train
15 Microscope holder pivot shaft
16 Bearing bracket of microscope holder
17 Hollow drive shaft
18 Microscope interface
19 Articulation flange for bracing spring
20 Bracing spring
21 Angular position of microscope holder relative to carrier arm 4
22 Other positioning motor
23, 23a First positioning motor
24 Angular position of microscope holder relative to horizontal or relative to microscope holder pivot shaft 15
Bracing surface
26 Positioning member
27 Main axis of microscope
28 Surgical microscope
29 Angular position
30, 30a, 30b Carrier arm, vertical carrier arm of stand body 42
31 Telescope motor or drive for elongation of carrier arm
32 Telescope spindle
33 Crank member
34 Carrier arm, horizontal parallelogram carrier arm
Tie rod
36 Rotation axis
37 Control system
39 Threaded bushing
40 Vertical carrier arm, pivotable vertical parallelogram vertical carrier arm
41 Shaft
42 Stand body
44a, 44b, 44c, 44d Drive for length variation
45 Angle sensor
46 Proximal partial carrier arm bearing for 4f
47 Proximal partial carrier arm bearing for 4g
48 Carrier part
49 Spindle
50 Illumination device
51 Double arrow
52 Rotary bearing
53a, b Part of carrier arm 4
54 Balance weight
55 Shifting motor
56 Slide rail

What is claimed is:

1. A stand for a surgical microscope (28) having an optical main axis (27), comprising:
a pivotable carrier arm (4; 34) mounted in a pivot bearing bracket (2) or in a pivotable vertical carrier arm (40);
a microscope holder (6) for reception of the surgical microscope (28) arranged at a distal end of the carrier arm (4; 34) and pivotable in at least one plane, the carrier arm (4; 34) having a definable angular position (29) with reference to the pivot bearing bracket (2) or to the pivotable vertical carrier arm (40) in order thereby to adjust the relative angular position of the carrier arm (4; 34) with reference to the horizontal;
wherein the carrier arm (4; 34) varies in length as a function of the angular position (29), such that the microscope holder (6) is variable in terms of its elevation along a perpendicular by pivoting motion and simultaneous length variation of the carrier arm (4; 34).

2. The stand according to claim 1, further comprising a control system (37), which defines the length variation as a measured function of the angular position (29) of the carrier arm (4) relative to the pivot bearing bracket (2) or to the vertical carrier arm (40);
wherein the carrier arm (4) varies in length automatically, in a manner coupled to the angular position (29), the carrier arm (4) configured to be lengthened or shortened preferably in motorized and sensor-controlled fashion.

3. The stand according to claim 1, wherein the carrier arm (4; 34) is telescopically extendable with respect to the pivot bearing bracket (2) or with respect to the vertical carrier arm (40).

4. The stand according to claim 3, wherein the carrier arm (4) includes a telescope motor or drive (31; 44) within the carrier arm (4), the telescope motor or drive (31; 44) being configured to modify the telescopic length modification of the carrier arm (4; 34).

5. The stand according to claim 1, wherein the pivotable carrier arm (4a; 4b; 4c; 4d, 4e) is a single tier or single arm, and is tubular or profile-shaped in section.

6. The stand according to claim 1, wherein the pivotable carrier arm (4; 34) has two tiers or with multiple parts, each of the two tiers or each of the multiple parts of the carrier arm (4c, 4d; 4f, 4g) having an extendable arm that is tubular or profile-shaped in section.

7. The stand according to claim 1, wherein the pivotable carrier arm (4; 34) is a trapezoidal parallelogram carrier arm (34).

8. The stand according to claim 1, wherein the carrier arm (4; 34), or at least one of the parts of the carrier arm (4a; 4f), is braced in weight-compensating fashion, with respect to the pivot bearing bracket (2; 2b) or with respect to a vertical carrier arm (30) and/or with respect to a stand body (42) or with respect to a second part of the carrier arm (4g) as applicable by a bracing spring (20) or by balance weights (50; 54).

9. The stand according to claim 1, further comprising a pivot/tilt sensor (10) configured to ascertain tilt of the microscope holder (6) or of the surgical microscope (28), the pivot/tilt sensor (10) configured to compensate for the tilt with a positioning motor (23; 23a; 22) via a microscope holder pivot shaft (15; 36).

10. The stand according to claim 1, wherein the microscope holder (6) is pivotable with respect to the carrier arm (4; 34) in a second plane, and the angular position (24) in the second plane as well is definable or compensatable by means of another drive or another positioning motor (22).

11. The stand according to claim 10, wherein the second plane is orthogonal to the first plane.

12. The stand according to claim 1, wherein the microscope holder (6) is suspended with respect to the carrier arm (4; 34) such that it automatically pivots or swings under its own weight, if the first and/or the other drive or positioning motor (23; 23a; 22) is inactive, at least approximately into a stipulated angular position (21; 24) or is subject to a torque in the direction of that close-to-perpendicular position at least until reaching that position.

13. The stand according to claim 12, wherein the stipulated angular position is close to the perpendicular.

14. The stand according to claim 1, wherein the microscope holder (6) is suspended with respect to the carrier arm (4; 34) such that its center of gravity is located to the side of a perpendicular through the suspension, and in the operating state the first and/or the other drive or positioning motor (23; 23a; 22) automatically absorbs or applies the resulting torque in order to pivot the microscope holder (6) into the desired angular position (21; 24).

15. The stand according to claim 14, wherein the microscope holder (6) is suspended with respect to the carrier arm (4; 34) such that its center of gravity is located to the side of a microscope holder pivot shaft (15) and/or to the side of a rotation axis (36) of the microscope holder (6).

16. The stand according to claim 1, wherein the microscope holder (6) is suspended with respect to the carrier arm (4; 34) with a clearance that, in the operating state, is compensated for or set to zero clearance by the first and/or the other drive or positioning motor (23; 23a; 22).

17. The stand according to claim 1, further comprising a control system (37) configured to define the definition of the angular position(s) (21; 24) as a function of the pivot-angle position (29) of the carrier arm (4; 34).

18. The stand according to claim 1, further comprising a pivot/tilt sensor (10), configured to, in the operating state, trigger the control system (37) or the first positioning motor (23; 23a) and/or the other positioning motor (22) to define the angular position(s) (21; 24) as a function of the pivot-angle position (29) of the carrier arm (4; 34).

19. The stand according to claim 18, wherein the pivot/tilt sensor (10) is at least one of the following sensors: tilt sensor, height sensor, angle sensor, IR-assisted spatial sensor.

20. The stand according to claim 1, wherein the motorized telescope motor (31; 44) or the first and/or the other positioning motor (23; 23a; 22) is at least one of the following: electric motor, geared motor, linear motor, rotary stepping motor, electroactive polymers (EAP).

21. The stand according to claim 1, wherein the drive (31; 44) and/or the first and/or the other positioning motor (23; 23a; 22) is self-locking.

22. The stand according to claim 1, wherein the drive (31; 44) and/or the first and/or the other positioning motor (23; 23a; 22) is decouplable via a releasable brake for manually moving the stand.
